(19) United States
(12) Patent Application Publication
(10) Pub. No.: US 2014/0314477 A1
(43) Pub. Date: Oct. 23, 2014

(54) CONNECTOR

(71) Applicants: Tsuyoshi Hamai, Makinohara-shi (JP); Akihiro Tsuruta, Fujieda-shi (JP); Nobuyuki Mukoujima, Fujieda-shi (JP)

(72) Inventors: Tsuyoshi Hamai, Makinohara-shi (JP); Akihiro Tsuruta, Fujieda-shi (JP); Nobuyuki Mukoujima, Fujieda-shi (JP)

(73) Assignee: YAZAKI CORPORATION, Tokyo (JP)

(21) Appl. No.: 14/343,067

(22) PCT Filed: Sep. 6, 2012
(86) PCT No.: PCT/JP2012/072799

§ 371 Date: May 13, 2014

(30) Foreign Application Priority Data
Sep. 6, 2011 (JP) 2011-194254

(51) Int. Cl. H01R 13/42

(52) U.S. Cl. CPC H01R 13/42
USPC 403/364

(57) ABSTRACT

A connector 11 includes a connector housing 13, terminal fittings 17, and a spacer 15 which is placed in a spacer attachment hole 21. Each spacer side surface 29 has a first lock projection 31 and a second lock projection 33. Each connector housing inner surface 23 is formed with a provisionally engaging portion 41 with which the first lock projection 31 is engaged in a provisionally lock state, a completely locking portion 47 with which the first lock projection 31 is engaged in a completely lock state, and an insertion force increasing portion 55 with which the second lock projection 33 is kept in contact when the spacer 15 is moved from a provisionally lock position to a completely lock position.

### TECHNICAL FIELD

The present invention relates to a connector which incorporates a spacer attached to a housing.

### BACKGROUND ART

Among known connectors are ones in which a spacer is attached to a connector housing in a provisionally lock state, terminal fittings are inserted into terminal housings with the spacer in the provisionally lock state, and then the spacer is rendered into a completely lock state to complete the attaching work (refer to Patent document 1).

A spacer 501 of the above kind shown in FIG. 13 is equipped with a connector housing 503, a plurality of metal fittings (not shown) which are housed and locked in a plurality of terminal housings 505 respectively formed in the connector housing 503, and a spacer 507 for locking the metal fittings doubly. A spacer attachment hole 509 for attachment of the spacer 507 is formed in the connector housing 503 so as to traverse the plurality of terminal housings 505. Left and right side walls 511 of the connector housing 503 are formed with respective locking portions 513 for the spacer 507 by thinning parts of the side walls 511 there.

Each locking portion 513 has a space 515 formed by the thinning of the side wall 511 and a provisionally locking portion 517 and a completely locking portion 519 which are formed in a wall bottom portion. The provisionally locking portion 517 and the completely locking portion 519 have roughly mountain-shaped and establish a lock state when a lock projection 521 falls into a valley. The lock projection 521 climbs over the provisionally locking portion 517 or the completely locking portion 519 of the connector housing 503 and falls into one of the valleys as a side wall 520 of the spacer 507 is bent, whereby the lock projection 521 is hooked. Thus, the spacer 507 is locked temporarily or regularly.

Patent document 2 etc. disclose a connector 525 having a retainer 523 as shown in FIG. 14. A plurality of terminal housing holes 529 are formed in a housing 527 of the connector 525 so as to be arranged in the top-bottom direction and the left-right direction. Projection lock pieces 531 project upward from the four respective corners of the top surface of the retainer 523. The tip of each projection lock piece 531 is formed with a provisionally fastening piece 537 or a completely fastening piece 539 to be locked on a provisionally locking projection 533 or a completely locking projection 535 and thereby fasten the retainer 523 at a provisionally lock position or a completely lock position. Among the four projection lock pieces 531, the two front ones have the provisionally fastening pieces 537 to be locked on locking projections 533, respectively, and the two rear ones have provisionally fastening pieces 53 to be locked on completely locking projections 535, respectively.

### PRIOR ART DOCUMENTS

### Patent Documents

Patent document 1: JP-A-2009-123570

Patent document 2: JP-UM-B-2594373

### SUMMARY OF THE INVENTION

### Problems to Be Solved by the Invention

However, if play exists between the above-described connector housing 503 or the housing 527 and the spacer 507 or the retainer 523, the spacer 507 or the retainer 523 may move to cause a transition from the provisionally lock state to the completely lock state during transport of the connector housing 503 or the housing 527.

The present invention has been made in the above circumstances, and an object of the present invention is to provide a connector which can prevent undesired movement of a spacer to a completely lock position.

### Means for Solving the Problems

The above object of the invention is attained by the following configurations:

(1) A connector comprising: a connector housing having a plurality of terminal housings which extend in a front-rear direction and are arranged at least in a left-right direction; terminal fittings housed and locked in the terminal housings; and a spacer configured to be placed in a spacer attachment hole which is formed so as to traverse the plurality of terminal housings, and the spacer being thereby locked temporarily or regularly, wherein a side surface of the spacer has a first lock projection which projects outward in the left-right direction and a second lock projection which is located on the rear side of the first lock projection in a spacer insertion direction and projects outward in the left-right direction; and wherein an inner surface of the connector housing has a provisionally engaging portion with which the first lock projection is engaged in a provisionally lock state, a completely locking portion with which the first lock projection is engaged in a completely lock state, and an insertion force increasing portion with which the second lock projection is kept in contact when the spacer is moved from a provisionally lock position to a completely lock position.

In the connector having the configuration of the above item (1), the spacer is inserted into the spacer insertion hole of the connector housing and the first lock projection which projects from the side surface of the spacer is engaged with a portion that is located between a provisionally engaging portion and a completely locking portion of the inner surface of the connector housing, whereby the spacer is held at the provisionally lock position. To be placed at the completely lock position, the first lock projection of the inserted spacer needs to climb over the completely locking portion and move to the front side of the completely locking portion in the spacer insertion direction. When the first lock projection climbs over the completely locking portion, the second lock projection which projects from the side surface of the spacer comes into contact with the insertion force increasing portion. As a result, the insertion load for the spacer in the spacer insertion direction is increased.

(2) The connector having the configuration of the above item (1), wherein the insertion force increasing portion is a level-different surface which makes the interval between left and right inner surfaces that define the spacer attachment hole smaller on the front side in the spacer insertion direction.

In the connector having the configuration of the above item (2), the level-different surface 57 is formed in such a manner that the interval between the left and right inner surfaces which defines the spacer attachment hole is smaller on the front side in the spacer insertion direction. That is, the interval between the left and right inner surfaces is wider on the rear side in the spacer insertion direction than on the front side. When the connector housing is molded, the spacer attachment hole is formed using a male die. At this time, the pulling direction of the male die is opposite to the spacer insertion direction. Therefore, the level-different surface can be formed without forming undercuts, and hence the insertion force increasing portion can be formed easily.

The invention has been described above in a simplified manner. The details of the invention will be made more apparent when the following modes for carrying out the invention (hereinafter referred to as an embodiment) are read with reference to the accompanying drawings.

### BRIEF DESCRIPTION OF THE DRAWINGS

FIG. 1 is a perspective view of a connector housing of a connector according to an embodiment of the present invention.

FIG. 2 is a sectional view, taken along arrow II-II, of the connector housing shown in FIG. 1.

FIG. 3(a) is an enlarged view of part A of FIG. 2, and FIG. 3(b) is an enlarged view of an essential part of FIG. 3(a).

FIG. 4 is a perspective view of a spacer of the connector according to the embodiment of the invention.

FIG. 5 is an enlarged front view of part B of FIG. 4.

FIG. 6(a) is a front view of the connector in which the spacer is inserted and placed at a provisionally lock position, and FIG. 6(b) is a side view corresponding to FIG. 6(a).

FIG. 7 is a sectional view, taken along arrow VII-VII, of the connector shown in FIG. 6(b).

FIG. 8 is a sectional view, taken along arrow VIII-VIII, of the connector shown in FIG. 6(b).

FIG. 9(a) is an enlarged view of part C of FIG. 7, and FIG. 9(b) is an enlarged view of an essential part of FIG. 9(a).

FIG. 10(a) is an enlarged view of part D of FIG. 8, and FIG. 10(b) is an enlarged view of an essential part of FIG. 10(a).

FIG. 11 is an enlarged view of an essential part of the connector in which the spacer shown in FIG. 9(a) has been moved to a completely lock position.

FIG. 12 is an enlarged view of an essential part showing a modification of an insertion force increasing portion.

FIG. 13 is a sectional view of a conventional connector having a spacer.

FIG. 14 is a sectional view of an essential part of a conventional connector having a retainer.

### MODES FOR CARRYING OUT THE INVENTION

A connector according to an embodiment of the present invention will be hereinafter described with reference to the accompanying drawings.

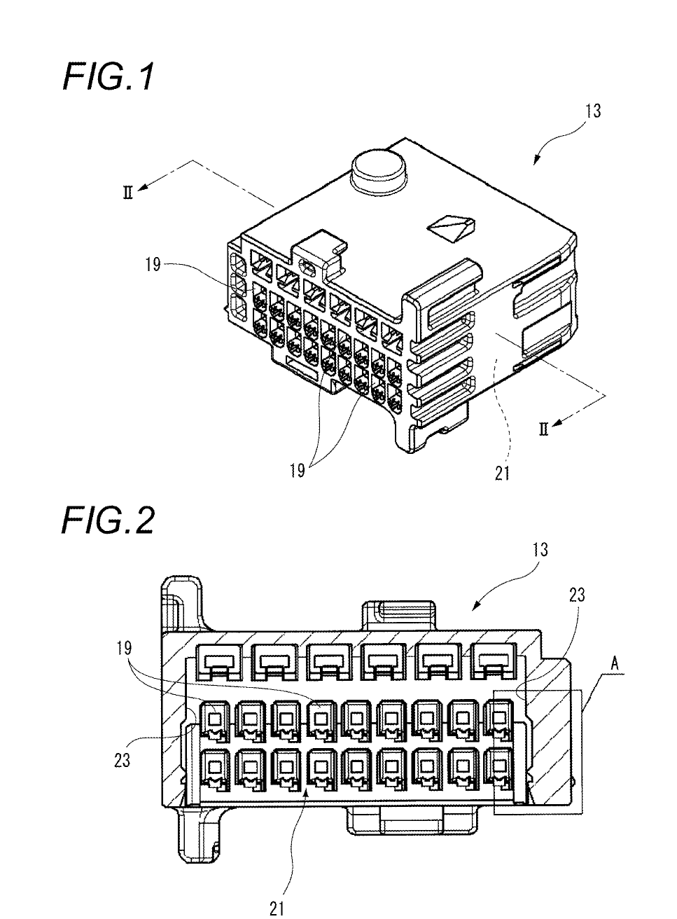

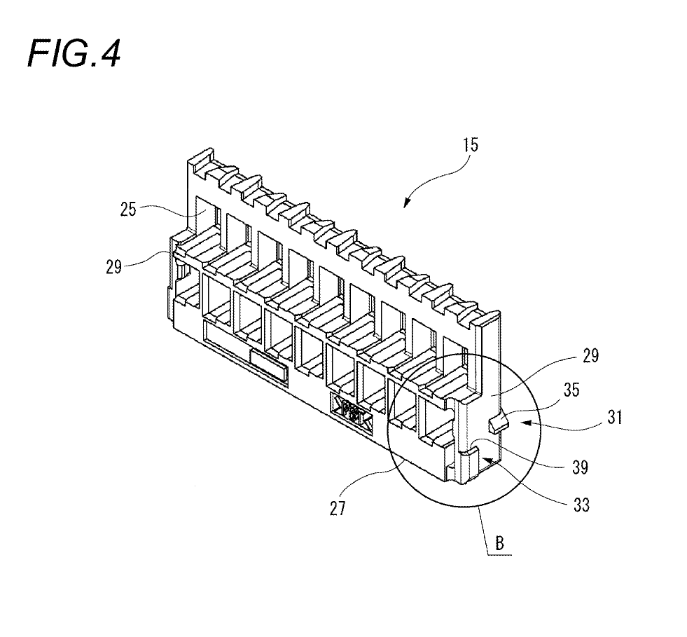

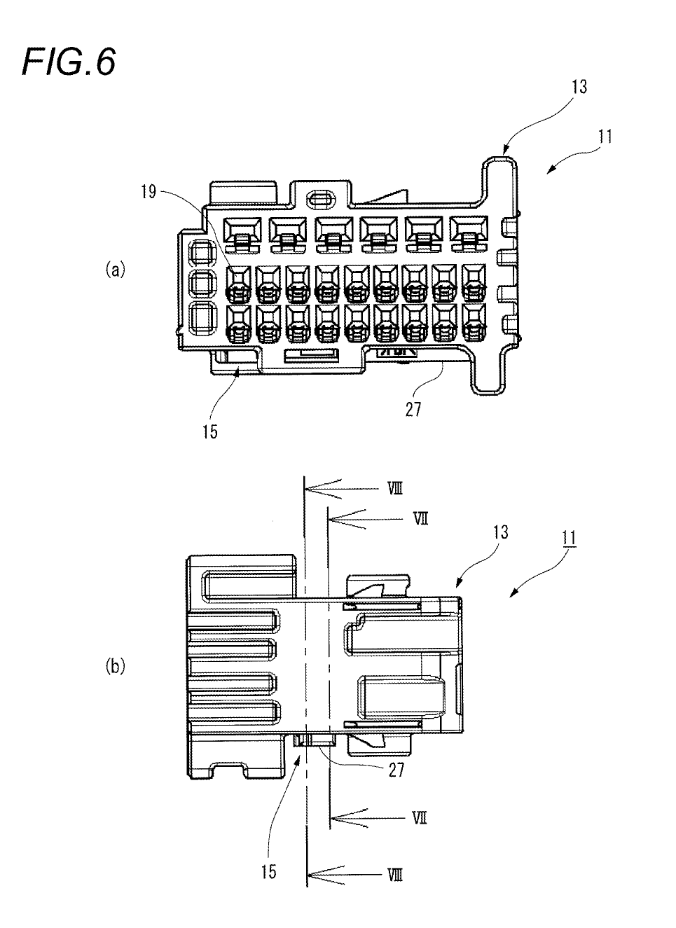

The connector 11 (see FIGS. 6(a) and 6(b)) is equipped with a spacer 15 (see FIG. 4) for increasing the terminals holding ability in such a manner that it can be inserted in a connector housing 13 shown in FIG. 1.

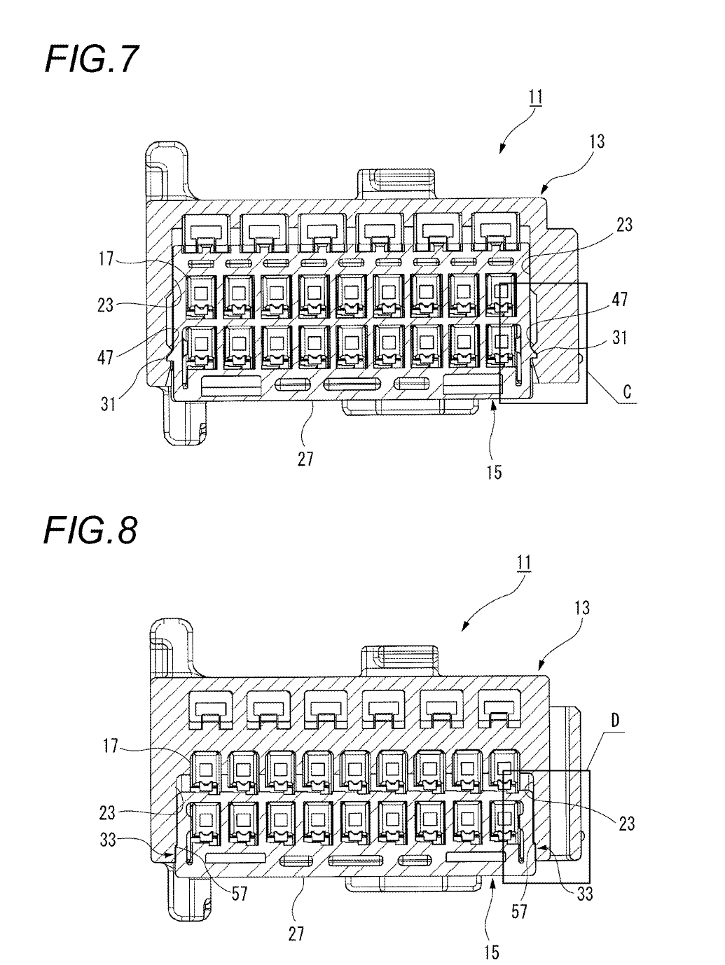

FIG. 1 shows only the connector housing 13 in a state that the spacer 15 is not attached to it. To insulate terminal fittings 17 (see FIG. 7) housed therein from other circuits, the connector housing 13 is molded with an insulative resin. To house the terminal fittings 17, a plurality of terminal housings 19 which extend in the front-rear direction (i.e., the insertion direction of the terminal fittings 17) are arranged at least in the left-right direction (i.e., the width direction of the terminal fittings 17).

Lances (not shown), which are elastic, flexible pieces, are locked on the respective terminal fittings 17 and thereby prevent the terminal fittings 17 from coming off are formed in the respective terminal housings 19. Sufficient locking strength for the terminal fittings 17 cannot be obtained only with the lances which are locked on the terminal fittings 17. Therefore, the terminals holding ability is increased by locking the terminal fittings 17 doubly by attaching the spacer 15.

The spacer 15 is inserted into the connector housing 13 from below (see FIG. 2), whereby an attached state shown in FIGS. 6(a) and 6(b) is established. The spacer 15 is attached before the terminal fittings 17 are attached to the connector housing 13. Before attachment of the terminal fittings 17, the spacer 15 is at a provisionally lock position (described later). The terminal fittings 17 are attached in this state, and the spacer 15 is thereafter moved relative to the connector housing 13 to a completely lock position.

As shown in FIG. 2, a spacer attachment hole 21 is formed in the connector housing 13 approximately at the center in the insertion direction of the terminal fittings 17 so as to traverse the terminal housings 19. The spacer attachment hole 21 is defined by left and right connector housing inner surfaces 23 of the connector housing 13.

The spacer 15 is shaped like a block body that is thin in the front-rear direction of the connector housing 13. A plurality of terminal insertion openings 25 which penetrate through the spacer 15 in the thickness direction (i.e., the insertion direction of the terminal fittings 17) are arranged vertically and horizontally so as to conform to the respective terminal housings 19. The spacer 15 is inserted into the spacer attachment hole 21 (see FIG. 2) from under the connector housing 13 shown in FIG. 1. That is, the spacer 15 is inserted so as to traverse the plurality of terminal housings 19. In the state that the spacer 15 is inserted in the connector housing 13, its terminal insertion openings 25 are aligned with the respective terminal housings 19 and a rear end portion 27 in the spacer insertion direction is exposed (see FIG. 6(a)). The rear end portion 27 of the spacer 15 is terminated by left and right spacer side surfaces 29.

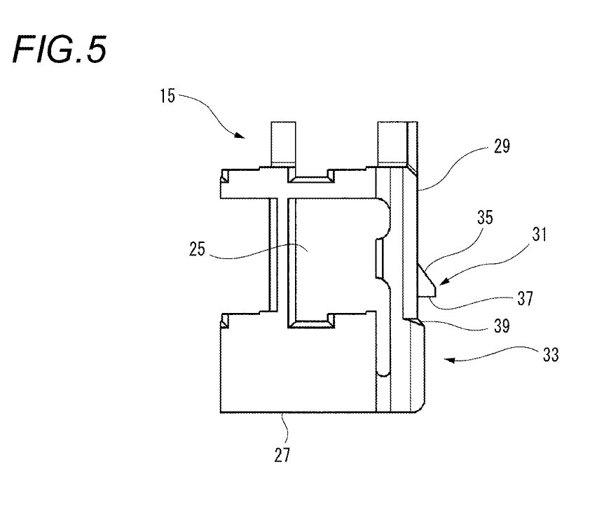

When inserted in the spacer attachment hole 21, the spacer 15 is rendered in a provisionally lock state or a completely lock state depending on its insertion position. As shown in FIGS. 4 and 5, each spacer side surface 29 is formed with a first lock projection 31 which projects outward in the left-right direction and a second lock projection 33 which projects outward in the left-right direction at a position that is in the rear of the first lock projection 31 in the spacer insertion direction. Although in the embodiment the first lock projection 31 is located in front of the second lock projection 33 in the spacer insertion direction (i.e., above the second lock projection 33 in FIG. 5), their arrangement is not limited to that.

The first lock projection 31 has a projection slant surface 35 on the front side in the spacer insertion direction and a projection vertical surface 37 on the opposite side. The second lock projection 33 is formed with a slightly inclined, small slant surface on the front side in the spacer insertion direction. The first lock projection 31 and the second lock projection 33 are offset from each other in the direction perpendicular to the paper surface of FIG. 5 (i.e., they do not form a single straight line extending in the spacer insertion direction). As shown in FIG. 4, the first lock projection 31 and the second lock projection 33 are formed on the same spacer side surface 29. Each spacer side surface 29 is elastically deformable though slightly. Not forming a single straight line extending in the spacer insertion direction, each of the first lock projection 31 and the second lock projection 33 does not influence the other when receiving pressing force from the connector housing inner surface 23.

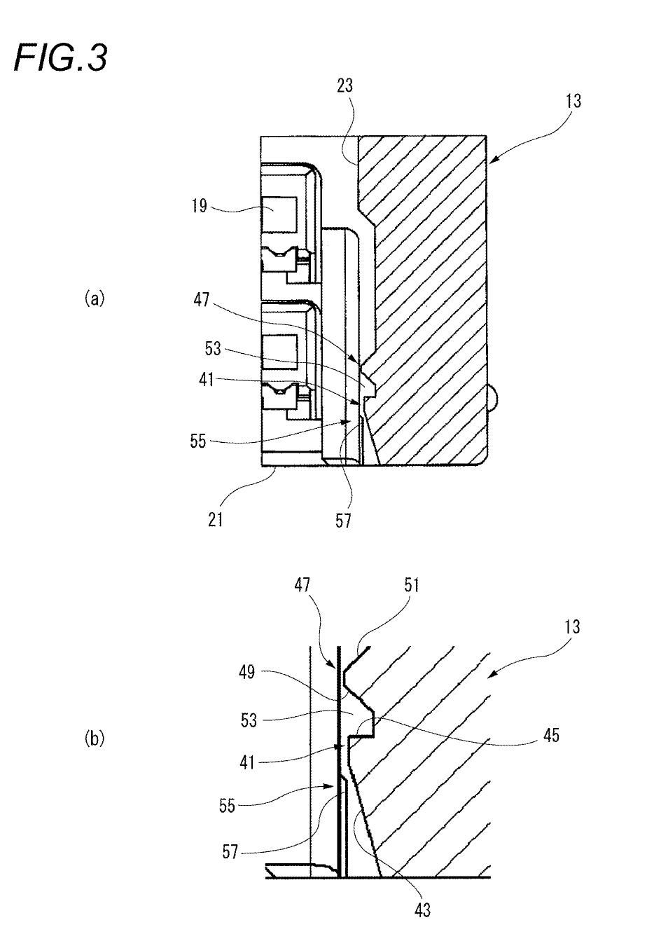

As shown in FIG. 3(a), a provisionally engaging portion 41 projects into the spacer attachment hole 21 from each of the connector housing inner surfaces 23 which define the spacer attachment hole 21. The first lock projection 31 is engaged with the provisionally engaging portion 41 in the provisionally lock state. The provisionally engaging portion 41 has an engaging portion slant surface 43 on the rear side in the spacer insertion direction and an engaging portion vertical surface 45 on the front side in the spacer insertion direction. A completely locking portion 47 is formed on the front side of the provisionally engaging portion 41 in the spacer insertion direction. The first lock projection 31 is engaged with the completely locking portion 47 in the completely lock state. The completely locking portion 47 has a completely locking portion rear slant surface 49 and a completely locking portion front slant surface 51 in the spacer insertion direction and is thus mountain-shaped in a sectional view.

The connector housing inner surface 23 is formed with a provisionally locking recess 53 between the provisionally engaging portion 41 and the completely locking portion 47. The spacer 15 is placed at the provisionally lock position when the first lock projection 31 is put into the provisionally locking recess 53. The spacer 15 is placed at the completely lock position as a result of an action that the first lock projection 31 moves from the provisionally lock position to the completely lock position climbing over the completely locking portion 47. The first lock projection 31 can return to the provisionally lock position because the completely locking portion 47 is mountain-shaped in a sectional view. After returning to the provisionally lock position, the spacer 15 is restrained so as not to move further from the provisionally lock position because the projection vertical surface 37 of the first lock projection 31 hits the engaging portion vertical surface 45 of the provisionally engaging portion 41. That is, the connector 11 can be transported with the spacer 15 held in this state in the connector housing 13.

Furthermore, as shown in FIG. 3(b), the connector housing inner surface 23 is formed with an insertion force increasing portion 55. In the embodiment, the insertion force increasing portion 55 is a level-different surface 57 in which the interval between the left and right inner surfaces which defines the spacer attachment hole 21 is smaller on the front side in the spacer insertion direction. That is, the interval between the left and right inner surfaces is wider on the rear side in the spacer insertion direction than on the front side. When the connector housing 13 is molded, the spacer attachment hole 21 is formed using a male die. At this time, the pulling direction of the male die is opposite to the spacer insertion direction. Therefore, the level-different surface 57 can be formed without forming undercuts, and hence the insertion force increasing portion 55 can be formed easily.

When the spacer 15 is moved from the provisionally lock position to the completely lock position, the level-different surface 57 is brought into contact with the second lock projection 33.

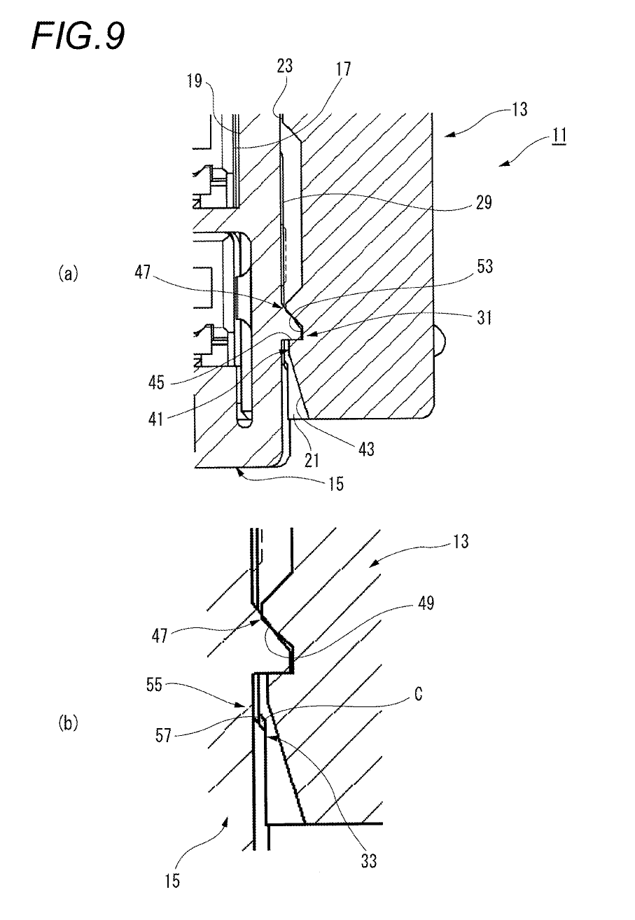

When the spacer 15 is located at the provisionally lock position, a small clearance C (see FIG. 9(b)) exists between the level-different surface 57 and the second lock projection 33. The clearance C prevents a phenomenon that at the provisionally lock position the second lock projection 33 hits the level-different surface 57 because of the presence of manufacturing allowances and the locking length of the first lock projection 31 in the provisionally locking recess 53 is thereby decreased.

Next, a description will be made of how the connector 1 having the above configuration operates.

In the connector 11, before attachment of the terminal fittings 17, the spacer 15 is inserted into the spacer attachment hole 21. In the connector 11, as shown in FIG. 8, after the insertion of the spacer 15 into the spacer attachment hole 21, the first lock projection 31 climbs the engaging portion slant surface 43 of the provisionally engaging portion 41 (see FIG. 9) and is then engaged with the engaging portion vertical surface 45. That is, the first lock projection 31 of the spacer 15 is engaged with the provisionally locking recess 53, whereby the spacer 15 is held at the provisionally lock position.

The connector 11 is transported with the spacer 15 located at this provisionally lock position. As shown in FIG. 7, at the provisionally lock position, the terminal fittings 17 are attached to the respective terminal housings 19. After the attachment of the terminal fittings 17, the spacer 15 is moved to the completely lock position to increase the holding ability for the terminal fittings 17.

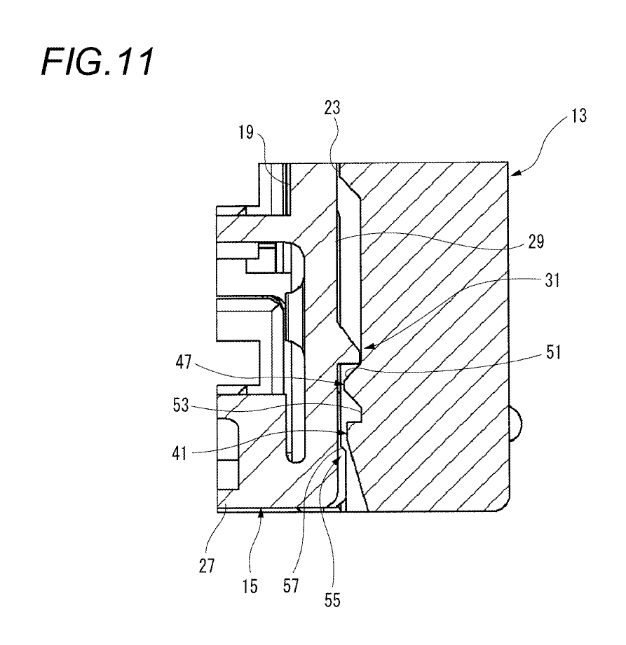

As soon as movement of the spacer 15 from the provisionally lock position to the completely lock position is started, the first lock projection 31 shown in FIG. 9 climbs the completely locking portion rear slant surface 49 of the completely locking portion 47. Subsequently, as shown in FIG. 11, the first lock projection 31 is locked on the completely locking portion front slant surface 51, whereby the spacer 15 is placed at the completely lock position. Thus, the attachment of the pacer 15 to the connector housing 13 is completed. At the completely lock position, the first lock projection 31 is locked on the completely locking portion front slant surface 51. Thus, the first lock projection 31 can retreat climbing the completely locking portion front slant surface 51. In this manner, the spacer 15 can be moved from the completely lock position to the provisionally lock position to cancel the completely locking.

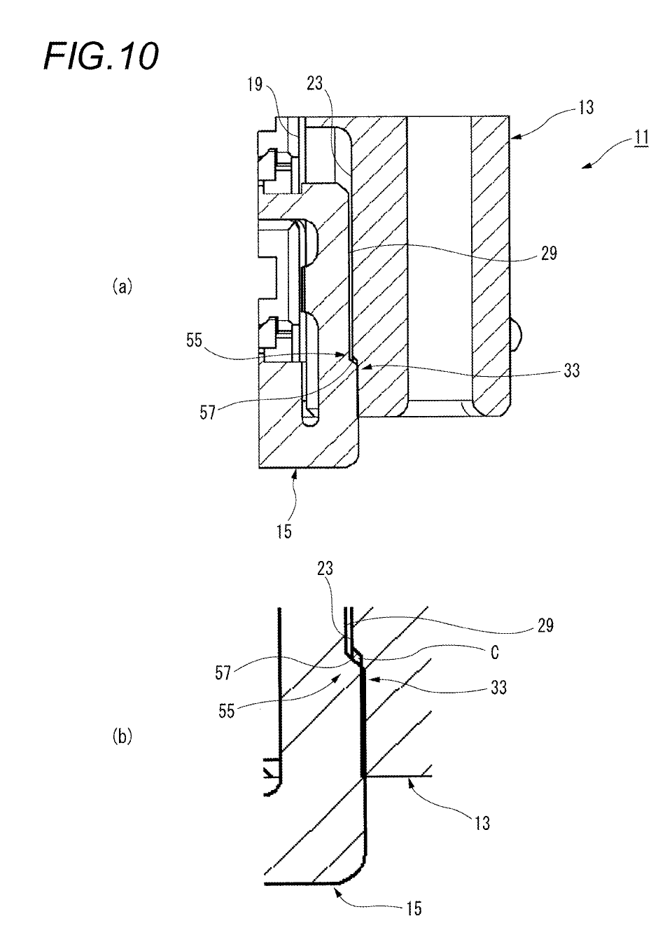

Incidentally, in conventional connectors, when they are transported with the spacer located at the provisionally lock position, the spacer may be moved to the completely lock position due to external force of vibration, a collision, inertia, or the like or deformation due to environmental stress. In contrast, in the connector 11 according to the embodiment, when the spacer 15 is located at the provisionally lock position, the second lock projection 33 of the spacer 15 shown in FIGS. 10(a) and 10(b) is opposed to the level-different surface 57 of the connector housing inner surface 23. If, for example, the spacer 15 receives external force of moving it toward the completely lock position from the provisionally lock position during transport, the second lock projection 33 hits the level-different surface 57.

Since the second lock projection 33 hits the level-different surface 57, the insertion load for the spacer 15 in the insertion direction is increased, as a result of which the spacer 15 is no longer moved to the completely lock position by deformation due to external force applied during transport or environmental stress. In this manner, in the connector 11, the spacer 15 is prevented from being moved to the completely lock position undesirably during transport.

In the connector 11, at the completely lock position, the second lock projection 33 is placed on the level-different surface 57. That is, the second lock projection 33 and the level-different surface 57 deform the spacer side surface 29 and the connector housing inner surface 23 in such directions that they go away from each other. Since at this time the second lock projection 33 is offset from the first lock projection 31, at the completely lock position the locking length of the first lock projection 31 with respect to the completely locking portion 47 is not decreased (see FIG. 11).

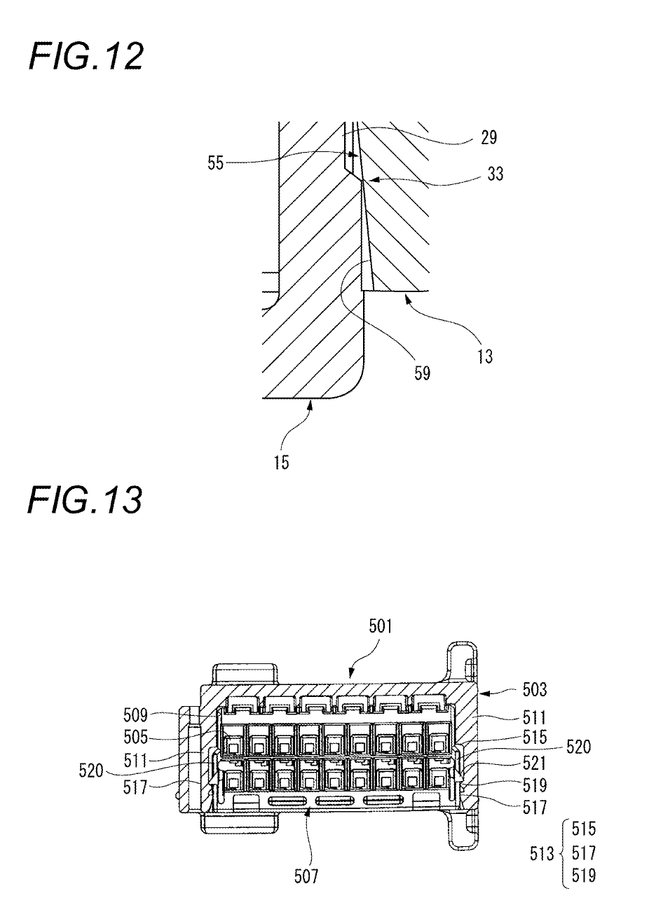

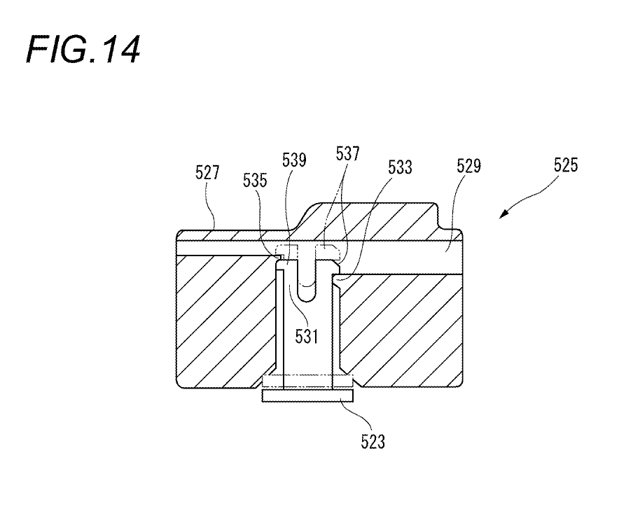

Although the above embodiment is directed to the case that the insertion force increasing portion 55 is formed as the level-different surface 57, as shown in FIG. 12 the insertion force increasing portion 55 may be implemented as a tapered surface 59. The tapered surface 59 is tapered in such a manner that the interval between the left and right inner surfaces which define the spacer attachment hole 21 is decreased gradually as the position goes forward in the spacer insertion direction. Also with the structure of this modification, the insertion force that is necessary to move the spacer 15 from the provisionally lock position to the completely lock position is increased. Thus, the spacer 15 can be prevented from being moved to the completely lock position undesirably.

As described above, according to the connector 11 of the embodiment, the second lock projection 33 being in contact with the insertion force increasing portion 55 increases the insertion force that is necessary to move the spacer 15 from the provisionally lock position to the completely lock position. Thus, the spacer 15 can be prevented from being moved to the completely lock position undesirably.

The features of the above-described connector according to the embodiment of the invention will be summarized below as items i and ii:

[i] A connector 11 comprising:

a connector housing 13 having a plurality of terminal housings 19 which extend in a front-rear direction and are arranged at least in a left-right direction;

terminal fittings 17 housed and locked in the terminal housings 19; and

a spacer 15 configured to be placed in a spacer attachment hole 21 which is formed so as to traverse the plurality of terminal housings 19, and the spacer 15 being thereby locked temporarily or regularly,

wherein a side surface 29 of the spacer (spacer side surface) has a first lock projection 31 which projects outward in the left-right direction and a second lock projection 33 which is located on the rear side of the first lock projection 31 in a spacer insertion direction and projects outward in the left-right direction; and

wherein an inner surface 23 of the connector housing (connector housing inner surface) has a provisionally engaging portion 41 with which the first lock projection 31 is engaged in a provisionally lock state, a completely locking portion 47 with which the first lock projection 31 is engaged in a completely lock state, and an insertion force increasing portion 55 with which the second lock projection 33 is kept in contact when the spacer 15 is moved from the provisionally lock position to the completely lock position.

[ii] The connector 11 recited in the above item [i], wherein the insertion force increasing portion 55 is a level-different surface 57 which makes the interval between left and right inner surfaces that define the spacer attachment hole 21 smaller on the front side in the spacer insertion direction.

Although the connector according to the invention has been described above in detail with reference to the particular embodiment, the invention is not limited the above embodiment and various modifications, improvements, etc. can be made as appropriate. And the material, shape, dimensions, number (where plural ones are provided), location, etc. of each constituent element of the above-described embodiment are optional and are not restricted as long as the invention can be implemented.

The present application is based on Japanese Patent Application No. 2011-194254 filed on Sep. 6, 2011, the disclosure of which is incorporated herein by reference.

### INDUSTRIAL APPLICABILITY

According to the connector which is based on the invention, the second lock projection being in contact with the insertion force increasing portion increases the insertion force that is necessary to move the spacer from the provisionally lock position to the completely lock position. Thus, the spacer can be prevented from being moved to the completely lock position undesirably.

### DESCRIPTION OF SYMBOLS

11 . . . Connector
13 . . . Connector housing
15 . . . Spacer
17 . . . Terminal fitting
19 . . . Terminal housing
21 . . . Spacer attachment hole
23 . . . Connector housing inner surface (inner surface of connector housing)
29 . . . Spacer side surface (side surface of spacer)
31 . . . First lock projection
33 . . . Second lock projection
41 . . . Provisionally engaging portion
47 . . . Completely locking portion
55 . . . Insertion force increasing portion
57 . . . Level-different surface 57

1. A connector comprising:
a connector housing having a plurality of terminal housings which extend in a front-rear direction and are arranged at least in a left-right direction;
terminal fittings housed and locked in the terminal housings; and
a spacer configured to be placed in a spacer attachment hole which is formed so as to traverse the plurality of terminal housings, and the spacer being thereby locked temporarily or regularly,
wherein a side surface of the spacer has a first lock projection which projects outward in the left-right direction and a second lock projection which is located on the rear side of the first lock projection in a spacer insertion direction and projects outward in the left-right direction; and
wherein an inner surface of the connector housing has a provisionally engaging portion with which the first lock projection is engaged in a provisionally lock state, a completely locking portion with which the first lock projection is engaged in a completely lock state, and an insertion force increasing portion with which the second lock projection is abutted in contact when the spacer is moved from a provisionally lock position to a completely lock position.

2. The connector according to claim 1, wherein the insertion force increasing portion is a level-different surface which makes an interval between left and right inner surfaces that define the spacer attachment hole smaller on the front side in the spacer insertion direction.
